(19) United States
(12) Patent Application Publication
(10) Pub. No.: US 2005/0195462 A1
(43) Pub. Date: Sep. 8, 2005

(54) Interference display plate and manufacturing method thereof

(75) Inventor: Wen-Jian Lin, Hsinchu City (TW)

Correspondence Address: Richard L. Byrne, 700 Koppers Building, 436 Seventh Avenue, Pittsburgh, PA, 15219-1818, US

(73) Assignee: PRIME VIEW INTERNATIONAL CO., LTD.

(21) Appl. No.: 10/884,555

(22) Filed: Jul. 2, 2004

(30) Foreign Application Priority Data
Mar. 5, 2004 (TW) 93105952

(51) Int. Cl. G02F 1/1345; G02B 26/00

(52) U.S. Cl. 359/290

(57) ABSTRACT

An optical interference display plate has a substrate, a protection structure, a plurality of color-changeable pixels and a plurality of supports. The color-changeable pixels are located on the substrate. The protection structure encloses the color-changeable pixels such that a gap is maintained between it and the substrate. The supports are located between the color-changeable pixels and the protection structure, and ends thereof are higher than the color-changeable pixels for preventing the color-changeable pixels from being damaged by a deformation of the protection structure.

### BACKGROUND

1. Field of Invention

The present invention relates to a display panel. More particularly, the present invention relates to an optical interference display panel.

2. Description of Related Art

Due to being lightweight and small in size, a display panel is favorable in the market of portable displays and other displays with space limitations. To date, in addition to liquid crystal display (LCD), organic light emitting diode (OLED) and plasma display panel (PDP) modules, an optical interference display module has been investigated.

U.S. Pat. No. 5,835,255 discloses a modulator array, that is, a color-changeable pixel for visible light which can be used in a display panel. FIG. 1A illustrates a cross-sectional view of a prior art modulator. Every modulator 100 comprises two walls, 102 and 104. These two walls are supported by posts 106, thus forming a cavity 108. The distance between these two walls, the depth of cavity 108, is D. The wall 102 is a light-incident electrode which, according to an absorption factor, absorbs visible light partially. The wall 104 is a light-reflective electrode that becomes flexed when a voltage is applied to it.

When the incident light shines through the wall 102 and arrives at the cavity 108, only the visible light with wavelengths corresponding to the formula 1.1 is reflected back, that is,
2D=Nλ (1.1)
wherein N is a natural number.

When the depth of the cavity 108, D, equals one certain wavelength λ₁ of the incident light multiplied by any natural number, N, a constructive interference is produced, and a light with the wavelength λ₁ is reflected back. Thus, an observer viewing the panel from the direction of the incident light will observe light with the certain wavelength λ₁ reflected back at him. The modulator 100 here is in an “open” state.

FIG. 1B illustrates a cross-sectional view of the modulator 100 in FIG. 1A after a voltage is applied to it. Under the applied voltage, the wall 104 is flexed by electrostatic attraction toward the wall 102. At this moment, the distance between the walls 102 and 104, the depth of cavity 108, becomes d and may equal zero.

The D in the formula 1.1 is hence replaced with d, and only the visible light with another certain wavelength λ₂ satisfying the formula 1.1 produces constructive interference in the cavity 108 and reflects back through the wall 102. However, in the modulator 100, the wall 102 is designed to have a high absorption rate for the light with the wavelength λ₂. Thus, the incident visible light with the wavelength λ₂ is absorbed, and the light with other wavelengths has destructive interference. All light is thereby filtered, and the observer is unable to see any reflected visible light when the wall 104 is flexed. The modulator 100 is now in a “closed” state.

As described above, under the applied voltage, the wall 104 is flexed by electrostatic attraction toward the wall 102 such that the modulator 100 is switched from the “open” state to the “closed” state. When the modulator 100 is switched from the “closed” state to the “open” state, the voltage for flexing the wall 104 is removed, and the wall 104 elastically returns to the original state, i.e. the “open” state, as illustrated in FIG. 1A.

However, the light-reflective electrode (the wall 104) is a membrane, typically made of metal, and generally is manufactured with a “sacrificial layer” technique widely used in the production of micro electro mechanical systems (MEMS). The light-reflective electrode is very thin and is easily damaged by even a tiny external force, inhibiting it from functioning properly. Moreover, the cavity 108 that spaces the two walls 102 and 104 is hollow. In practice, an external environment usually affects and lowers the display performance of the color-changeable pixel 100 because of the thin cavity 108.

The prior art therefore provides an optical interference display panel having a protection structure. FIG. 2A illustrates a sectional view of a conventional optical interference display panel having a protection structure. The optical interference display panel has a substrate 110, a plurality of color-changeable pixels 100 and a protection structure 204. The protection structure 204 is adhered to the substrate 110 with an adhesive 202 having spacers, thus enclosing the color-changeable pixels therebetween. The combination of the protection structure 204 and the substrate 100 can reduce the possibility of the color-changeable pixels 100 being damaged by touch, in addition to shielding the color-changeable pixels 100 from water, dust and oxygen in the air.

However, when the modem optical interference display panel becomes larger or thinner, or the material of the protection structure 204 is flexible, this conventional technique, which only uses the adhesive 202 having spacers to support the protection structure 204, has some problems. For example, if the display panel is too large or too thin, the protection structure 204 is easily deformed and brought into contact with the light-reflective electrodes (the wall 104), causing damage to the color-changeable pixels 100, as illustrated in FIG. 2B. Another situation is that when some portions of the display panel are pressed, by fingers or by the impact of other hard objects, the protection structure 204 easily impinges the color-changeable pixels 100, as illustrated in FIG. 2C.

### SUMMARY

It is therefore an objective of the present invention to provide an optical interference display panel to mitigate the deformation of the protection structure while the display panel is large or thin and to raise the selectivity of the flexible material of the protection structure.

It is another objective of the present invention to provide a method for manufacturing an optical interference display panel to prevent the protection structure from damaging the color-changeable pixels and to enhance the portability and the convenience of the optical interference display panel.

In accordance with the foregoing and other objectives of the present invention, an optical interference display panel is provided. The optical display panel has a substrate, a protection structure, a plurality of color-changeable pixels and a plurality of first supports. The color-changeable pixels are located on the substrate. The protection structure encloses the color-changeable pixels such that a gap exists between it and the substrate. The first supports are located between the color-changeable pixels and the protection structure, and first ends thereof are higher than the color-changeable pixels to prevent the color-changeable pixels from being damaged by a deformation of the protection structure.

The method of manufacturing the optical interference display panel comprises first providing a substrate and then forming a plurality of color-changeable pixels on the substrate. A plurality of first supports are formed on the color-changeable pixels. A protection structure is joined to the substrate such that the color-changeable pixels are positioned between the protection structure and the substrate.

According to one preferred embodiment of the present invention, each of the color-changeable pixels comprises a first electrode on the substrate, a second electrode situated in parallel with the first electrode substantially, and a second support located on the first electrode to support the second electrode. A portion of the second support is not covered by the second electrode.

The step of forming the color-changeable pixels comprises forming a first electrode on the substrate and then forming a sacrificial layer on the first electrode. A plurality of first openings are formed in the first electrode and the sacrificial layer, and a second support is formed in each of the first openings. A second electrode is formed on the sacrificial layer and the second support, such that a portion of the second support is not covered by the second electrode. Then, the sacrificial layer is removed by a release etching process.

In the preferred embodiment, the first supports are located on the first electrodes, or on portions of the second supports. In other words, before removing the sacrificial layer, a plurality of second openings are formed in the first electrode and the sacrificial layer, and the first supports are then either formed in the second openings or on portions of the second supports.

A material of the first supports is a photoresist, a dielectric material or a conductive material. In the preferred embodiments, according to considerations for processing, the materials of the first and second supports must have different etching selectivities to facilitate the process of forming the second electrode and the second supports.

Moreover, the first ends of the first supports are not connected to the protection structure, and second ends of the first supports are connected to the color-changeable pixels. The foregoing step of joining comprises adhering the protection structure to the substrate with an adhesive, and the adhesive comprises spacers to keep a predetermined distance between the protection structure and the substrate to prevent the color-changeable pixels from being damaged by touching the protection structure. The adhesive comprises a UV glue or a thermosetting adhesive.

According to another preferred embodiment of the present invention, the first ends of the first supports are connected to the protection structure, and second ends of the first supports are connected to the color-changeable pixels. Besides the adhesive having spacers, an adhesive without spacers can also be used to adhere the protection structure to the substrate in order to prevent the protection structure from damaging the color-changeable pixels by using only the first supports.

It is to be understood that both the foregoing general description and the following detailed description are examples and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1A illustrates a cross-sectional view of a prior art modulator;

FIG. 1B illustrates a cross-sectional view of the modulator in FIG. 1A after a voltage is applied to it;

FIG. 2A illustrates a sectional view of a conventional optical interference display panel having a protection structure;

FIG. 2B illustrates a sectional view of a conventional optical interference display panel having a protection structure which is pressed;

FIG. 2C illustrates a sectional view of a conventional optical interference display panel having a protection structure which is deformed;

FIG. 3 illustrates a schematic top view of one preferred embodiment of the present invention;

FIGS. 4A and 4B depict a method for manufacturing the embodiment in FIG. 3;

FIG. 5A illustrates a sectional view of one preferred embodiment taken along line AA′ in FIG. 3;

FIG. 5B illustrates a sectional view of one preferred embodiment taken along line BB′ in FIG. 3;

FIG. 6A illustrates a sectional view of another preferred embodiment taken along line AA′ in FIG. 3; and

FIG. 6B illustrates a sectional view of another preferred embodiment taken along line BB′ in FIG. 3.

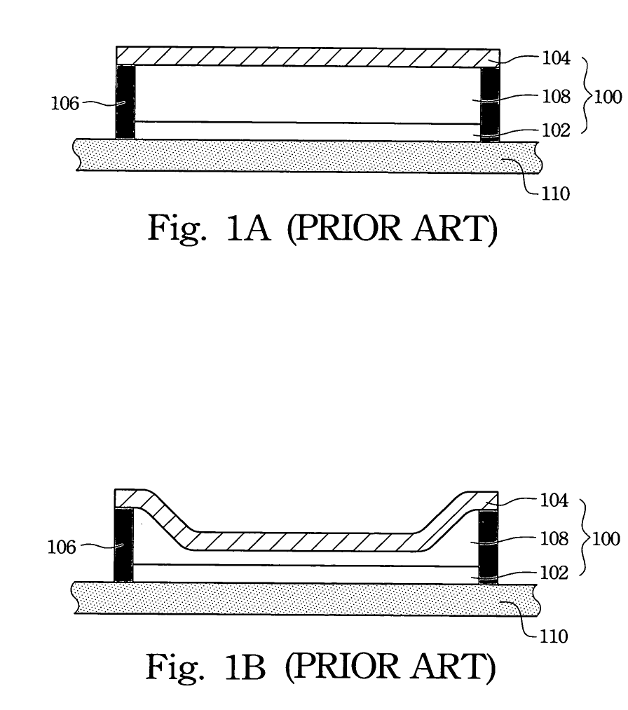

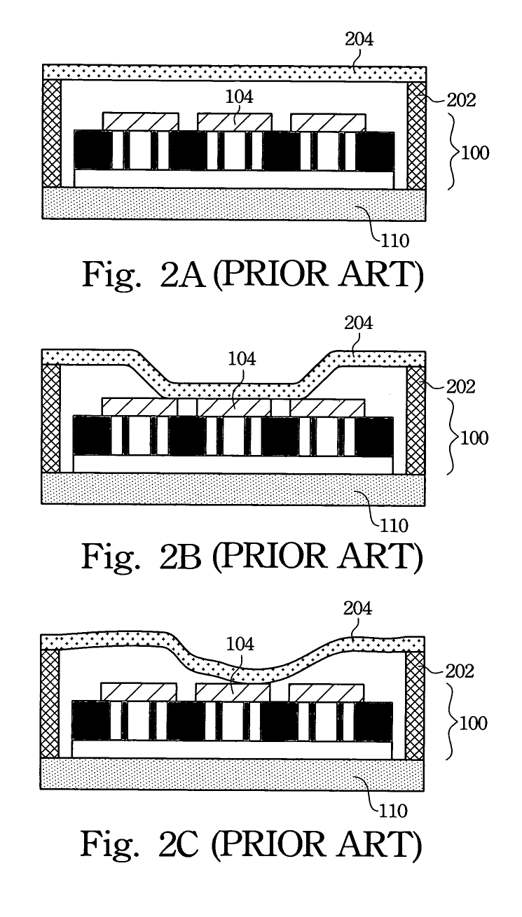

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

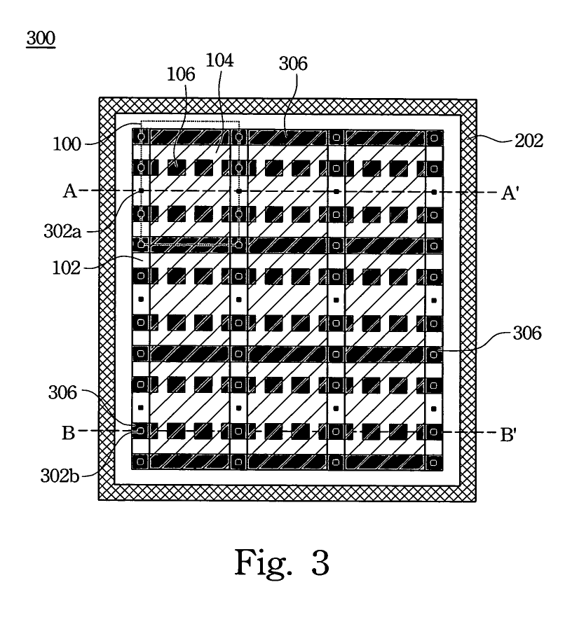

FIG. 3 is a schematic top view of one preferred embodiment of the present invention, which illustrates an optical interference display panel 300 from the side of a protection structure (not shown in figure). As illustrated in FIG. 3, a color-changeable pixel 100 has a light-incident electrode 102 and a light-reflective electrode 104 parallel to the light-incident electrode 102. Posts 106 are located between the two electrodes 102 and 104 for support. Moreover, a second support is positioned between two neighboring color-changeable pixels 100 and is located on the light-incident electrode 102 to support the light-reflective electrode 104 as the posts 106. It is noted that a portion of each second support 306 is not covered by the light-reflective electrode 104.

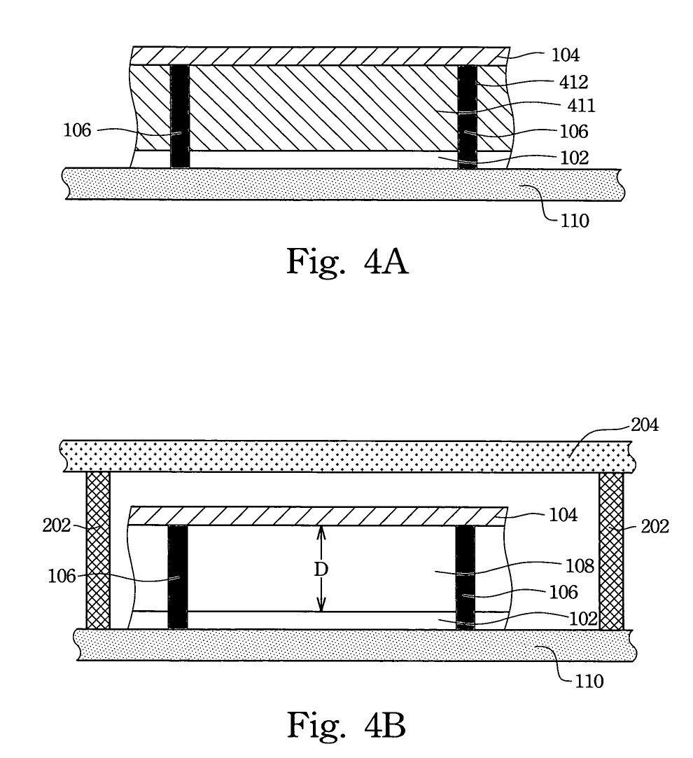

FIGS. 4A and 4B depict a method for manufacturing the embodiment in FIG. 3. For clarity, only one color-changeable pixel is represented in the figures and the following description. Reference is made to FIG. 4A first, in which a light-incident electrode 102 and a sacrificial layer 411 are formed in order on a substrate 110. First openings 412 are formed in the light-incident electrode 102 and the sacrificial layer 411, and every opening 412 is suitable for forming one post 106 therein. Next, posts 106 are formed in the first openings 412, and a light-reflective electrode 104 is formed on the sacrificial layer 411 and the posts 106.

Reference is made to FIG. 4B, in which the sacrificial layer 411 is removed by a release etching process, such as a remote plasma etch process, to form a cavity 108. The depth D of the cavity 108 is the thickness of the sacrificial layer 411. Afterward, a protection structure 204 is adhered to the substrate 110 with an adhesive 202. A pressing procedure is used to make the adhesion between the protection structure 204 and the substrate 110 more intimate. The adhesive 202 is a UV glue or a thermosetting adhesive. A gap is preserved between the protection structure 204 and the color-changeable pixels 100.

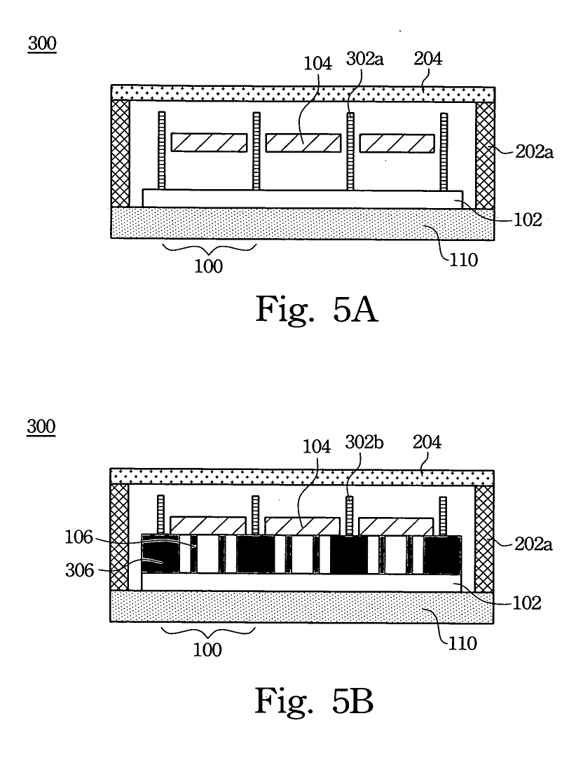

In the preferred embodiment, the first supports 302a are located on the light-incident electrodes 102, and optionally, the first supports 302b are located on the portions of the second supports 306 where they are exposed by the light-reflective electrodes 104. FIG. 5A illustrates a sectional view of one preferred embodiment taken along line AA′ in FIG. 3, and FIG. 5B illustrates a sectional view of one preferred embodiment taken along line BB′ in FIG. 3. The following descriptions interpret two situations: when the first supports are located on the light-incident electrodes 102 as in FIG. 5A; and when the first supports are located on the second supports 306 as in FIG. 5B.

As illustrated in FIG. 5A, the first supports 302a are located on the light-incident electrodes 102 and between the two neighboring color-changeable pixels 100. In this embodiment, a plurality of second openings (not illustrated in the figure) are formed in the light-incident electrodes 102 and the sacrificial layer 411, and the first supports 302a are then formed in the second openings before removing the sacrificial layer 411.

As illustrated in FIG. 5B, the first supports 302b are located on the portions of the second supports 306 where they are uncovered by the light-reflective electrodes 104 and located between the two neighboring color-changeable pixels 100. In this embodiment, the first supports 302b are formed on the uncovered portions of the second supports 306 before removing the sacrificial layer 411.

A material of the first supports 302a and 302b is a photoresist, a dielectric material or a conductive material. In the preferred embodiments of the present invention, according to considerations for processing, the materials of the first supports 302a and 302b must have different etching selectivity from those of the second supports 306 and the light-reflective electrodes 104 in order to facilitate the process of forming the light-reflective electrodes 104 and the second supports 306.

Moreover, in the preferred embodiments, the first ends of the first supports 302a and 302b are not connected to the protection structure 204, and the second ends of the first supports 302a and 302b are connected to the light-incident electrodes 102 of the color-changeable pixels 100. The foregoing step of joining comprises adhering the protection structure 204 to the substrate 110 with an adhesive 202a, and the adhesive 202a comprises spacers to keep a predetermined distance between the protection structure 204 and the substrate 110 in order to prevent the color-changeable pixels 100 from being damaged by the protection structure 204 while being pressed.

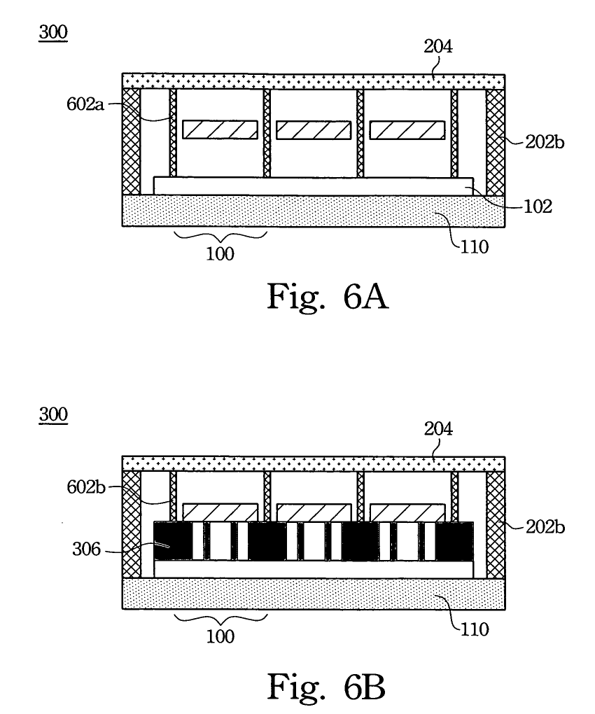

Besides the foregoing embodiments in which the first supports 302a and 302b are not connected to the protection structure 204, according to another preferred embodiment of the present invention, the first supports 302a and 304b can be connected to the protection structure 204. FIG. 6A illustrates a sectional view of another preferred embodiment taken along line AA′ in FIG. 3, and FIG. 6B illustrates a sectional view of another preferred embodiment taken along line BB′ in FIG. 3. The following descriptions interpret situations when the first supports are located on the light-incident electrodes 102 and when the first supports are located on the second supports 306, wherein both cases, connection is made to the protection structure 204 as shown in FIGS. 6A and 6B.

As illustrated in FIGS. 6A and 6B, the first ends of the first supports 602a and 602b are connected to the protection structure 204, and the second ends of the first supports 602a and 602b are connected to the light-incident electrodes 102 and the second supports 306, respectively. Besides the adhesive 202a having spacers as the foregoing embodiments, an adhesive 202b without spacers can also be used to adhere the protection structure 204 to the substrate 110 in order to prevent the protection structure 204 from damaging the color-changeable pixels 100 by using only the first supports 602a and 602b.

It is noted that the above-mentioned four different first supports 302a, 302b, 602a and 602b can be used at the same time in the same optical interference display panel to provide an optimized effect according to the application requirements.

The invention prevents the protection structure from damaging the color-changeable pixels of the optical interference display panel. When some portion of the display panel is pressed, such as done by fingers or by the impact of other hard objects, the invention can prevent the deformation of the protection structure due to pressing from damaging the color-changeable pixels. Moreover, when the display panel is large or thin, the invention can also mitigate the deformation of the protection structure. Therefore, the invention enhances the capability of the display panel for being larger or thinner. Furthermore, the invention raises the selectivity of the flexible material of the protection structure and also enhances the portability and the convenience of the optical interference display panel.

It will be apparent to those skilled in the art that various modifications and variations can be made to the structure of the present invention without departing from the scope or spirit of the invention. In view of the foregoing, it is intended that the present invention cover modifications and variations of this invention provided that they fall within the scope of the following claims and their equivalents.

1. An optical interference display panel, comprising:
a substrate;
a plurality of color-changeable pixels on the substrate;
a protection structure covering the color-changeable pixels, wherein a gap is preserved between the protection structure and the color-changeable pixels; and
a plurality of first supports located between the color-changeable pixels and the protection structure, and a height of first ends of the first supports is higher than a height of the color-changeable pixels;
wherein the first supports protect the color-changeable pixels from being damaged from a deformation of the protection structure.

2. The optical interference display panel of claim 1, wherein each of the color-changeable pixels comprises:
a first electrode on the substrate;
a second electrode situated in parallel with the first electrode substantially; and
a second support located on the first electrode to support the second electrode, wherein a portion of the second support is not covered by the second electrode.

3. The optical interference display panel of claim 2, wherein the first supports are located on the first electrodes.

4. The optical interference display panel of claim 2, wherein the first supports are located on portions of the second supports.

5. The optical interference display panel of claim 1, wherein the first ends of the first supports are connected to the protection structure, and second ends of the first supports are connected to the color-changeable pixels.

6. The optical interference display panel of claim 5, wherein the protection structure is adhered to the substrate with an adhesive.

7. The optical interference display panel of claim 6, wherein the adhesive comprises a UV glue or a thermosetting adhesive.

8. The optical interference display panel of claim 1, wherein the first ends of the first supports are not connected to the protection structure, and second ends of the first supports are connected to the color-changeable pixels.

9. The optical interference display panel of claim 8, wherein the protection structure is adhered to the substrate with an adhesive, and the adhesive comprises spacers to keep a predetermined distance between the protection structure and the substrate.

10. The optical interference display panel of claim 9, wherein the adhesive comprises a UV glue or a thermosetting adhesive.

11. The optical interference display panel of claim 1, wherein a material of the first supports is a photoresist, a dielectric material or a conductive material.

12. An method for manufacturing an optical interference display panel, the method comprising:
providing a substrate;
forming a plurality of color-changeable pixels on the substrate;
forming a plurality of first supports on the color-changeable pixels, and a height of first ends of the first supports is higher than a height of the color-changeable pixels; and
joining a protection structure to the substrate in order to position the color-changeable pixels between the protection structure and the substrate.

13. The method of claim 12, wherein the step of forming the color-changeable pixels comprises:
forming a first electrode on the substrate;
forming a sacrificial layer on the first electrode;
forming a plurality of first openings in the first electrode and the sacrificial layer;
forming a second support in each of the first openings;
forming a second electrode on the sacrificial layer and the second support, wherein a portion of the second support is not covered by the second electrode; and
removing the sacrificial layer by a release etching process.

14. The method of claim 13, wherein the method further comprises forming a plurality of second openings in the first electrode and the sacrificial layer, and forming the first supports in the second openings before removing the sacrificial layer.

15. The method of claim 13, wherein the method further comprises forming the first supports on the portions of the second supports before removing the sacrificial layer.

16. The method of claim 12, wherein the first ends of the first supports are connected to the protection structure, and second ends of the first supports are connected to the color-changeable pixels.

17. The method of claim 12, wherein the first ends of the first supports are not connected to the protection structure, and second ends of the first supports are connected to the color-changeable pixels.

18. The method of claim 12, wherein the step of joining comprises adhering the protection structure to the substrate with an adhesive.

19. The method claim 18, wherein the adhesive comprises spacers to keep a predetermined distance between the protection structure and the substrate.

20. The method of claim 18, wherein the adhesive comprises a UV glue or a thermosetting adhesive.

21. The method of claim 12, wherein a material of the first supports is a photoresist, a dielectric material or a conductive material.
